(19) United States
(12) Patent Application Publication
(10) Pub. No.: US 2021/0099212 A1
(43) Pub. Date: Apr. 1, 2021

(54) UPLINK TRANSMISSION MODE SELECTION AND TRIGGERING

(71) Applicant: QUALCOMM Incorporated, San Diego, CA (US)

(72) Inventors: Xiaolong HUANG, San Jose, CA (US); Nathaniel David HOUGHTON, San Jose, CA (US); Ahmed Ragab ELSHERIF, San Jose, CA (US); Madhavan NAIR, San Ramon, CA (US); Chao ZOU, San Jose, CA (US)

(21) Appl. No.: 16/587,450

(22) Filed: Sep. 30, 2019

(51) Int. Cl. H04B 7/06; H04B 7/0452; H04L 5/00; H04B 7/0426

(52) U.S. Cl. CPC H04B 7/0634; H04B 7/0426; H04L 5/0007; H04B 7/0452

(57) ABSTRACT

This disclosure provides methods, apparatuses, wireless nodes and computer-readable mediums for wireless communications. In one aspect, a method is provide for dynamic selection and triggering of uplink (UL) transmission (TX) modes. A method that may be performed by an access point (AP) includes dynamically selecting an UL single user (SU) TX mode, an UL multiple user (MU) multiple input multiple output (MIMO) TX mode, or an UL orthogonal frequency division multiple access (OFDMA) TX mode. The AP communicates with one or more stations (STAs) based on the dynamically selected UL TX mode.

### TECHNICAL FIELD

This disclosure relates generally to wireless communications, and more particularly to uplink transmission mode selection and triggering, for example, in a wireless local area network (WLAN).

### DESCRIPTION OF THE RELATED TECHNOLOGY

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The deployment of wireless local area networks (WLANs, sometimes referred to as WiFi networks) in the home, the office, and various public facilities is commonplace today. Such networks typically employ a wireless access point (AP) that connects a number of wireless stations (STAs) in a specific locality (such as the aforementioned home, office, public facility, etc.) to another network, such as the Internet or the like. A set of STAs can communicate with each other through a common AP in what is referred to as a basic service set (BSS).

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of WLAN air interface standards developed by the IEEE 802.11 committee for short-range communications (such as tens of meters to a few hundred meters).

### SUMMARY

The systems, methods, apparatuses, computer-readable mediums, and wireless nodes of this disclosure each have several innovative aspects, no single one of which is solely responsible for the desirable attributes disclosed herein.

One innovative aspect of the subject matter described in this disclosure can be implemented in a method for wireless communications by an access point (AP). The method generally includes dynamically selecting an uplink (UL) single user (SU) transmission mode, an UL multiple user (MU) multiple input multiple output (MIMO) transmission mode, or an UL orthogonal frequency division multiple access (OFDMA) transmission mode. The method generally incudes communicating with one or more stations (STAs) based on the dynamically selected UL transmission mode.

In some implementations, the dynamic selection includes selecting the UL SU transmission mode when there is only one active UL STA. In some implementations, when there is more than one active UL STA, the dynamic selection may include selecting between the transmission modes using heuristics. In some implementations, when there is more than one active UL STA, the dynamic selection may include selecting between the transmission modes based on estimated throughput for the transmission modes.

One innovative aspect of the subject matter described in this disclosure can be implemented in an apparatus for wireless communications. The apparatus generally includes a processing system configured to dynamically select an UL SU transmission mode, an UL MU MIMO transmission mode, or an UL OFDMA transmission mode. The apparatus generally incudes an interface configured to communicate with one or more STAs based on the dynamically selected UL transmission mode.

One innovative aspect of the subject matter described in this disclosure can be implemented in an apparatus for wireless communications. The apparatus generally includes means for dynamically selecting an UL SU transmission mode, an UL MU MIMO transmission mode, or an UL OFDMA transmission mode. The apparatus generally incudes means for communicating with one or more STAs based on the dynamically selected UL transmission mode.

One innovative aspect of the subject matter described in this disclosure can be implemented in a computer readable medium storing computer executable code thereon for wireless communications. The computer readable medium generally includes code for dynamically selecting an UL SU transmission mode, an UL MU MIMO transmission mode, or an UL OFDMA transmission mode. The computer readable medium generally incudes code for communicating with one or more STAs based on the dynamically selected UL transmission mode.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a system diagram of an example network in which one or more aspects of the subject matter described in this disclosure can be implemented.

FIG. 2 shows a block diagram of example devices shown in FIG. 1.

FIG. 3 shows an example of uplink (UL) multiple user (MU) multiple input multiple output (MIMO).

FIG. 4 shows an example of uplink of orthogonal frequency division multiple access (OFDMA).

FIG. 5 shows a flow diagram of example operations for participating in wireless sensing.

FIG. 6 illustrates a communications device that may include various components configured to perform operations for the techniques disclosed herein.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, and the IEEE 802.3 Ethernet standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or Internet-of-Things (IOT) network, such as a system utilizing 3G, 4G or 5G, or further implementations thereof, technology.

One or more innovative aspects of the subject matter described in this disclosure relate to uplink (UL) transmission (TX) mode selection and triggering. Various UL TX modes may be desirable in different scenarios. Thus, techniques for dynamically selecting and triggering the appropriate UL TX mode are useful. In some examples, the techniques, which are described in greater detail below, may be used in a WiFi network (such as in an 802.11ax system) to dynamically select and trigger the UL TX mode. In some examples, the UL TX modes may include selecting between an UL single user (SU) TX mode, an UL multi-user (MU) multiple input multiple output (MIMO) TX mode, and an UL orthogonal frequency division multiple access (OFDMA) TX mode. In some examples, the dynamic UL TX mode selection is based on heuristics. In some examples, the dynamic UL TX mode selection is based on estimated throughput for the different UL TX modes. The heuristic and estimated throughput techniques for the dynamical UL TX mode selection may be based on various parameters, such as number of active users, payload size, scheduling weights, rates, UL traffic types, UL transmission payloads, physical (PHY) layer rates, overhead, collisions, etc.

There are various advantages to UL TX mode selection and triggering performed in accordance with aspects of the subject matter described in this disclosure. One advantage is that the best performing UL TX mode can be dynamically selected for a given scenario, taking into account the parameters such as those mentioned above. The dynamic selection of the UL TX mode may allow for a balance between overhead, reduced latency, and improved throughput.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The teachings herein may be incorporated into (such as implemented within or performed by) a variety of wired or wireless apparatuses (such as nodes). In some aspects, a wireless node implemented in accordance with the teachings herein may include an access point (AP) or an access terminal (AT).

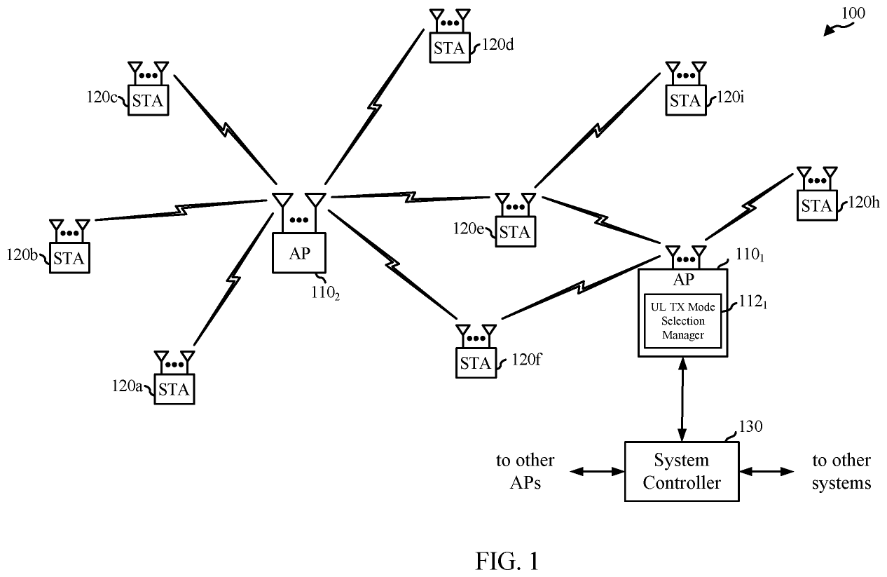

FIG. 1 shows a system diagram of an example network in which one or more aspects of the subject matter described in this disclosure can be implemented. The network 100 may be, for example, a multiple-access multiple-input multiple-output (MIMO) system with APs 110 and stations (STAs) 120 (which may be non-AP STAs). An AP is generally a fixed station that communicates with the STAs. AP 110₁ or AP 110₂ may communicate with one or more stations (STAs) 120 at any given moment on the downlink and uplink. The downlink (i.e., forward link) is the communication link from the access point to the user terminals, and the uplink (i.e., reverse link) is the communication link from the user terminals to the AP 110₁ or AP 110₂. An STA may also communicate peer-to-peer with another STA.

APs such as AP 110₁ and AP 110₂ may include, be implemented as, or known as a Node B, a Radio Network Controller (RNC), an evolved Node B (eNB), a Base Station Controller (BSC), a Base Transceiver Station (BTS), a Base Station (BS), a Transceiver Function (TF), a Radio Router, a Radio Transceiver, a Basic Service Set (BSS), an Extended Service Set (ESS), a Radio Base Station (RBS), or some other terminology.

A STA 120 may be fixed or mobile. An may include, be implemented as, or known as a subscriber station, an access terminal (AT), a subscriber unit, a mobile station (MS), a remote station, a remote terminal, a user terminal (UT), a user agent, a user device, user equipment (UE), a user station, or some other terminology. In some implementations, an STA 120 may include a cellular telephone, a cordless telephone, a Session Initiation Protocol (SIP) phone, a wireless local loop (WLL) station, a personal digital assistant (PDA), a handheld device having wireless connection capability, a Station (STA), or some other suitable processing device connected to a wireless modem. Accordingly, one or more aspects taught herein may be incorporated into a phone (such as a cellular phone or smart phone), a computer (such as a laptop), a portable communication device, a portable computing device (such as a personal data assistant), an entertainment device (such as a music or video device, or a satellite radio), a global positioning system device, or any other suitable device that is configured to communicate via a wireless or wired medium. In some aspects, the node is a wireless node. Such wireless node may provide, for example, connectivity for or to a network (such as a wide area network such as the Internet or a cellular network) via a wired or wireless communication link.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another (such as directly or indirectly) via a wireless or wireline backhaul.

While portions of the following disclosure will describe STAs 120 capable of communicating via Spatial Division Multiple Access (SDMA), for certain aspects, the STAs 120 may also include some STA that do not support SDMA. Thus, for such aspects, an AP 110 may be configured to communicate with both SDMA and non-SDMA stations. This approach may allow older versions of stations (“legacy” stations) to remain deployed in an enterprise, extending their useful lifetime, while allowing newer SDMA stations to be introduced as deemed appropriate.

The network 100 employs multiple transmit and multiple receive antennas for data transmission on the downlink and uplink. The AP 110 is equipped with Naₚ antennas and represents the multiple-input (MI) for downlink transmissions and the multiple-output (MO) for uplink transmissions. A set of K selected STAs 120 collectively represents the multiple-output for downlink transmissions and the multiple-input for uplink transmissions. For pure SDMA, it is desired to have Nₐₚ≥K≥1 if the data symbol streams for the K STAs are not multiplexed in code, frequency or time by some means. K may be greater than Naₚ if the data symbol streams can be multiplexed using TDMA technique, different code channels with CDMA, disjoint sets of subbands with OFDM, and so on. Each selected STA 120 transmits user-specific data to or receives user-specific data from the AP 110. In general, each selected STA 120 may be equipped with one or multiple antennas (i.e., Nᵤₜ≥1). The K selected STAs can have the same or different number of antennas.

The network 100 may be a time division duplex (TDD) system or a frequency division duplex (FDD) system. For a TDD system, the downlink and uplink share the same frequency band. For an FDD system, the downlink and uplink use different frequency bands. Network 100 also may utilize a single carrier or multiple carriers for transmission. Each STA 120 may be equipped with a single antenna (such as in order to keep costs down) or multiple antennas (such as where the additional cost can be supported). The network 100 also may be a TDMA system if the STAs 120 share the same frequency channel by dividing transmission/reception into different time slots, each time slot being assigned to different STA 120.

According to certain aspects, the APs 110 may be configured for UL TX mode selection and triggering. As shown in FIG. 1, the 110₁ includes an UL TX mode selection manager 112₁. The UL TX mode selection manager 112₁ may be configured to dynamically select the UL TX mode and communicate with STAs 120 using the dynamically selected UL TX mode, in accordance with aspects of the present disclosure. In some examples, the UL TX mode selection manager 112₁ may dynamically select between an UL SU TX mode, an UL MU-MIMO TX mode, and an UL OFDMA TX mode. In some examples, the UL TX mode selection manager 112₁ may dynamically select the UL TX mode selection based on heuristics. In some examples, the UL TX mode selection manager 112₁ may dynamically select the UL TX mode based on estimated throughput for the different UL TX modes.

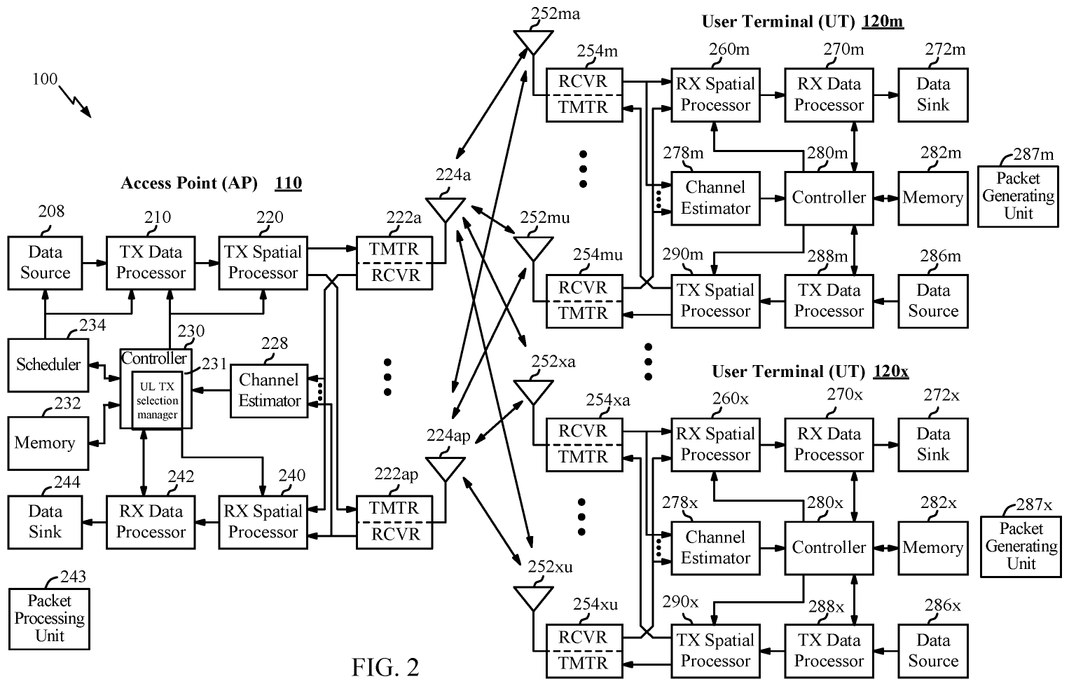

FIG. 2 shows a block diagram of example devices shown in FIG. 1. FIG. 2 illustrates a block diagram of AP 110 and two STAs 120m and 120x in network 100. The AP 110 is equipped with Nₜ antennas 224a-224t. STA 120m is equipped with N_{ut,m} antennas 252ma-252mu, and STA 120x is equipped with N_{ut,x} antennas 252xa-252xu. The AP 110 is a transmitting entity for the downlink and a receiving entity for the uplink. Each STA 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nᵤₚ STAs are selected for simultaneous transmission on the uplink, N_{dn} STAs are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the AP 110 and STA 120.

On the uplink, at each STA 120 selected for uplink transmission, a TX data processor 288 receives traffic data from a data source 286 and control data from a controller 280. TX data processor 288 processes (such as encodes, interleaves, and modulates) the traffic data for the STA 120 based on the coding and modulation schemes associated with the rate selected for the STA 120 and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (such as converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the AP 110.

Nᵤₚ STAs may be scheduled for simultaneous transmission on the uplink. Each of these STAs performs spatial processing on its data symbol stream and transmits its set of transmit symbol streams on the uplink to the access point.

At AP 110, Nₐₚ antennas 224a-224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (such as demodulates, deinterleaves, and decodes) each recovered uplink data symbol stream in accordance with the rate used for that stream to obtain decoded data. The decoded data for each STA may be provided to a data sink 244 for storage or a controller 230 for further processing. The controller 230 may be coupled with a memory 232.

On the downlink, at AP 110, a TX data processor 210 receives traffic data from a data source 208 for N_{dn} STAs scheduled for downlink transmission, control data from a controller 230, and possibly other data from a scheduler 234. The various types of data may be sent on different transport channels. TX data processor 210 processes (such as encodes, interleaves, and modulates) the traffic data for each STA based on the rate selected for that STA. TX data processor 210 provides N_{dn} downlink data symbol streams for the N_{dn} STAs. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the STAs 120. The decoded data for each STA may be provided to a data sink 272 for storage and/or a controller 280 for further processing.

At each STA 120, N_{ut,m} antennas 252 receive the Nₐₚ downlink signals from AP 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the STA 120. The receiver spatial processing is performed in accordance with the CCMI, MMSE or some other technique. An RX data processor 270 processes (such as demodulates, deinterleaves and decodes) the recovered downlink data symbol stream to obtain decoded data for the STA 120.

At each STA 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the STA 120 based on the downlink channel response matrix H_{dn,m} for that STA 120. Controller 230 derives the spatial filter matrix for the access point based on the effective uplink channel response matrix H_{up,eff}. Controller 280 for each STA 120 may send feedback information (such as the downlink or uplink eigenvectors, eigenvalues, SNR estimates, and so on) to the AP 110. Controllers 230 and 280 also control the operation of various processing units at AP 110 and STA 120, respectively.

The controller 230 and/or other processors and modules at the AP 110 may perform or direct the execution of processes for the techniques described herein for UL TX mode selection and triggering. For example, as shown in FIG. 2, the controller 230 of the AP 110 includes an UL TX mode selection manager 231. The UL TX mode selection manager 231 may be configured to dynamically select the UL TX mode and communicate with STAs 120 using the dynamically selected UL TX mode, in accordance with aspects of the present disclosure. In some examples, the UL TX mode selection manager 231 may dynamically select between an UL SU TX mode, an UL MU-MIMO TX mode, and an UL OFDMA TX mode. In some examples, the UL TX mode selection manager 231 may dynamically select the UL TX mode selection based on heuristics. In some examples, the UL TX mode selection manager 231 may dynamically select the UL TX mode based on estimated throughput for the different UL TX modes.

### Example UL TX Modes

As discussed above, aspects of the present disclosure relate to UL TX mode selection and trigger. In certain systems, such as WiFi (for example, 802.11ax systems), various UL TX modes can be used. The UL TX modes may include an UL OFDMA TX mode, an UL MU MIMO TX mode, and an UL SU TX mode.

In SU TX modes (such as in 802.11ac and earlier systems), only a single user station is allowed to transmit on the uplink at one time, although multi-user downlink MIMO from the AP to Non-AP STA may be supported through MIMO beamforming. The more users (or STAs) active in the network, the longer the STAs may wait before allowed to transmit. In SU-MIMO, all streams enabled by spatial multiplexing are sent from a single transmitter to a single receiver.

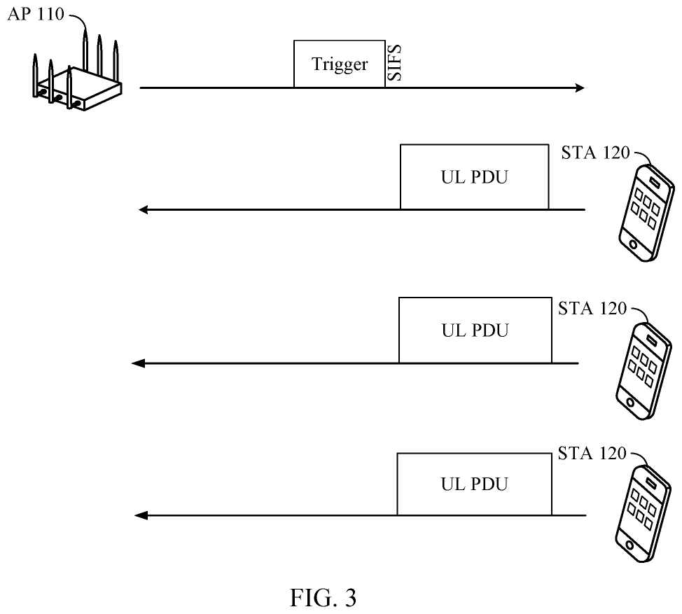

In UL-MU-MIMO, transmissions may originate at different clients and are simultaneously received by the AP. An MU-MIMO transmitter can use the spatial diversity to send N independent streams to N independent receivers. UL-MU-MIMO can use spatial diversity of the channel to send independent stream of data over the same bandwidth, but using different independent streams. Unlike OFDMA, all users can use the full bandwidth. The AP's receiver may cancel the interference between the different received data streams. Precoding may be applied to ensure that each stream does not create interference at the receivers for which it is not intended. Dedicated training sequences and responses, referred to as “sounding frames” and “sounding feedback” may be used to acquire knowledge of the channels between the AP and the various STAs for the precoding. FIG. 3 shows an example of UL MU MIMO. As shown in FIG. 3, a trigger frame may be sent by the AP 110 to trigger UL transmission (such as protocol data units (PDUs)) from the STAs 120.

OFDMA may enable simultaneous UL transmission by multiple users. OFDMA may be referred to as high efficient (HE) MU access and UL OFDMA may be referred to as Triggered Uplink Access (TUA). In some systems (such as LTE), OFDMA is time-based, where various tones correspond to different users during one Transmission Time Interval (TTI). In WiFi, OFDMA may be frame-based, where an MU frame contains data to/from different users and various tones are assigned to the users for the entire frame duration.

In OFDMA, a symbol is constructed of subcarriers, where the subcarriers defines the physical (PHY) layer bandwidth. Each user may be assigned different subsets of subcarriers to achieve simultaneous data transmission. The more subcarriers are used, the longer their symbol rate is, so that the overall rate of information remains the same. For example, in 20 MHz OFDMA bandwidth there may be a total of 256 subcarriers (tones) which are grouped in smaller sub-channels (or RUs). Thus, the number of RUs may be based on the system bandwidth. For example, there may be 9 RUs for 20 MHz, 18 RUs for 40 MHz, and so further other bandwidths (such as 80 MHz or 160 MHz). With OFDMA, different transmit powers may be applied to different resource units (RUs).

The RUs may enable an AP STA to allow multiple users to access the AP simultaneously. In some examples, a 26-tone RU, 52-tone RU, 106-tone RU, 242-tone RU, 484-tone RU, 996-tone RU, and/or a 2×996-tone RU may be used. In an illustrative example, when an AP supports 52-tone RUs for a 20-MHz bandwidth, 4 users can transmit and/or receive simultaneously to the AP (each STA uses 52-tones, but the total bandwidth for all users must be less than or equal the whole 20-MHz full allocated bandwidth).

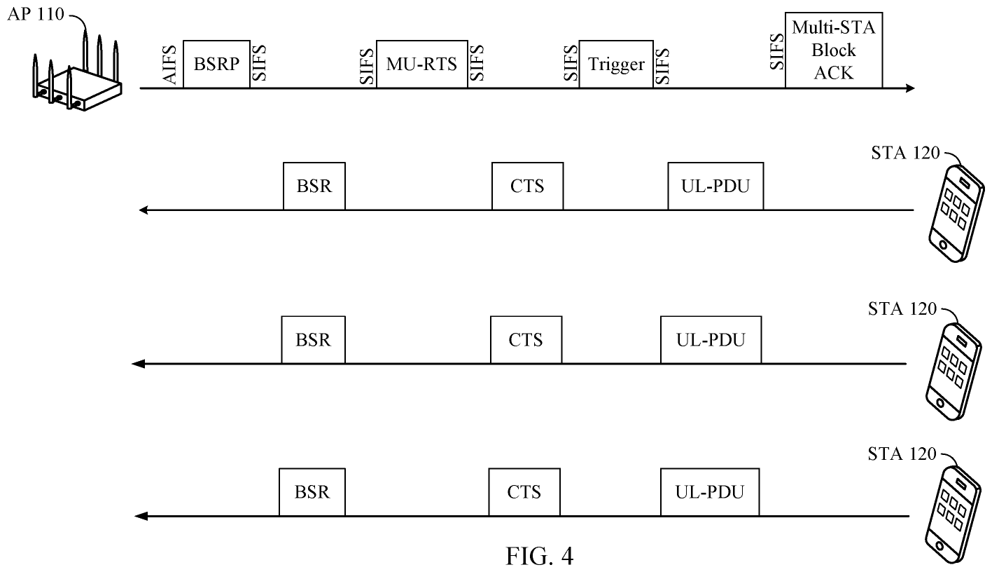

For UL OFDMA, a MAC trigger frame sent by the AP may be used to trigger simultaneous UL OFDMA transmissions by multiple users. The AP can control the timing of the UL transmissions by sending a trigger frame to targeted STAs to invite them to transmit uplink data. FIG. 4 shows an example of UL OFDMA. As shown in FIG. 4, the AP 110 may send a trigger frame to the STAs 120 to initiate UL OFDMA transmissions. The trigger frame may identify the STAs 120 to transmit and may assign RUs to those STAs. The trigger frame may indicate the duration for the UL OFDMA transmissions. As shown in FIG. 4, the STAs 120 receiving the trigger frame sends its own UL PDU back to the AP 110 (for example, using the assigned RUs). In some examples, as shown in FIG. 4, the UL OFDMA transmissions by the STAs 120 start one SIFS after the trigger frame. With UL OFDMA, the AP 110 can choose the best RU for each particular receiver, which may results in higher Signal-to-Interference-plus-Noise Ratio (SINR), Modulation and Coding Scheme (MC S) and throughput.

In some examples, for the AP 110 to allocate RUs only to STAs which have data to transmit, the AP 110 can request the STAs 120 to report the buffered data they have (such in the BSR) as shown in FIG. 4. In some examples, with enhanced distributed channel access (EDCA), the AP and STAs may contend for access to the medium. In some examples, the AP 110 and STAs 120 use a request-to-send (RTS) clear-to-send (CTS), as shown in FIG. 4, before triggering the UL data transmissions. As shown in FIG. 4, the AP 110 can acknowledge the UL PDUs from the STAs 120 using a multi-STA block ACK (BA) frame.

In various scenarios, various UL TX modes may be desirable. In some examples, UL OFDMA in a WiFi network (such as an 11ax system) may have decreased performance, or poor performance as compared to another UL TX mode.

In an example, when there is only 1 active UL traffic user, UL OFDMA may perform worse compared to UL SU due to overhead.

In another example, when there are multiple active users, but the collision and the contention among UL SU users are not significant (such as below a threshold), UL OFDMA may perform worse compared to UL SU due to overhead. Because UL SU can use a shorter (such as 0.8 μs) guard interval (GI) and UL OFDMA may use a longer GI, the collision contention reduction gain of UL OFDMA may be offset by its longer GI.

In yet another example, UL OFDMA may have decreased performance, or poor performance as compared to another UL TX mode, when many (such as more than a threshold) of the middle RU26s cannot be used and, therefore, the power spectral density (PSD) boost gain of UL OFDMA may be offset by the less efficient use of the BW.

In various scenarios, however, UL OFDMA has good performance, or better performance as compared to other UL TX modes. For example, when users have small payload, UL OFDMA may provide better preamble amortization gain as well as channel access latency. For small packet payload, both UL OFDMA and UL-MU-MIMO may have benefits over SU by reduction of transmission overhead; however, the sounding for MU-MU-MIMO may reduce the effective throughput. For larger payload sizes, the relative contribution of transmission overhead becomes smaller and, therefore, the relative gain of UL OFDMA may decrease.

Accordingly, techniques and apparatus for the AP to dynamically choose among UL TX modes (such as UL SU, UL n-user OFDMA, and UL MU-MIMO), for example so as to benefit the throughput and latency, are desirable.

### Example UL TX Mode Selection and Triggering

Aspects of the present disclosure provide techniques and apparatus for an access point (AP) to dynamically between uplink (UL) transmission (TX) modes, that may be used in a wireless local area network (WLAN), such as an 802.11ax WiFi system. In some examples, the AP can dynamically select between an UL single user (SU) transmission mode, an UL multiple user (MU) multiple input multiple output (MIMO) transmission mode, and an UL orthogonal frequency division multiple access (OFDMA) transmission mode. The selection may be based on heuristic, or based on estimated throughput for the different UL TX modes. The selection may be based on various parameters for various scenarios.

According to certain aspects, the AP can select the UL TX mode based on a heuristic process. In some examples, the heuristic process is used when the users (such as non-AP stations (STAs) or user terminals (UTs)) have similar traffic and channel conditions. In some examples, the users may be grouped and/or configured with similar traffic and channel conditions.

With the heuristic process, the AP selects the UL SU TX mode when there is only a single (one) active UL user. When there are multiple users, the AP selects the UL MU-MIMO transmission when all of the followings are true: the highest scheduling user (such as the user with the highest scheduling weight or quality-of service (QoS) scheduling weight that may be assigned by the AP to assign scheduling priority to the users) is UL MU-MIMO capable; there are some large payload users (for example users with a payload above a threshold, such as a 300 μs SU payload duration); some users rates are sufficiently high to have UL MU-MIMO gain (for example users with an SU rate above threshold, such as (MCS-1/NSS-2|MCS-3/NSS-1)) which may be users that are not too distant (such as further than a threshold distance) from the AP.

Otherwise, the AP does not select the UL MU-MIMO TX mode and, instead, the AP selects between the UL OFDMA TX mode and the UL SU TX mode. In this case, the AP selects the UL OFDMA TX mode if there are more than 1 small payload user among the highest scheduling weight users; if there are a sufficient amount of users (such as more than 4 users); if the UL OFDMA power spectral density (PSD) boosted throughput is higher than the UL SU throughput; and/or if there are a large number of users (such as 8 or more) causing collisions using UL SU mode. The small payload may include management information and may be urgent (such as high priority) to provide as soon as possible.

Otherwise, the AP does not select the UL OFDMA TX mode and, instead, selects the UL SU TX mode.

According to certain aspects, the AP can select the UL TX mode based on estimated throughputs for the different UL TX modes. In some examples, the heuristic process is used when the users do not have similar traffic and/or channel conditions.

With the threshold estimation process, if there is only one active UL user, the AP selects the UL SU TX mode, otherwise (when there are multiple active users), the AP selects the UL TX mode with a highest estimated throughput based on several parameters.

In some examples, for the threshold estimation process, the AP identifies UL traffic types. For example, the AP may identify users with latency sensitive type traffic, such as transport control protocol (TCP) traffic acknowledgment (ACK) traffic, real-time traffic, etc.

In some examples, for the threshold estimation process, the AP identifies the payload of each user.

In some examples, for the threshold estimation process, the AP determines physical layer (PHY) rates for each of the users. For example, the AP may determine the PHY rates for the users at a same path loss and taking into account the modulation coding scheme (MCS), number of spatial streams (NSS), and/or guard period (HI), and/or other factors affecting the PHY rate, for each of the STAs. The AP may determine PHY rates for the user for each of the UL TX modes. For example, the AP may determine the PHY rates for each user for the UL SU TX mode, for the UL OFDMA TX mode, and for the UL MU-MIMO TX mode. For the UL OFDMA TX mode, the AP may determine the users PHY rates for each of the UL OFDMA PSD boosted of RU26, RU52, RU106, RU242, RU484, and RU996 modes. For the UL MU MIMO TX mode, the AP may determine the users PHY rates for each of the UL MU-MIMO MU-1/2/3/4/5/6/7/8 modes (with 1, 2, . . . 8 users, respectively).

In some examples, for the threshold estimation process, the AP identifies the overhead of the UL SU, UL OFDMA, and UL MU-MIMO TX modes. In determining the overhead, the AP may take into account contention overhead, collisions, trigger frame overhead, and/or acknowledgement frame overhead.

Using the identified parameters above, the AP can estimate the throughput (such as the peak throughput) for the different UL TX modes in order to dynamically select one of the UL TX modes to use for communicating.

In some examples, the AP sets the minimum number of users (n-user) for UL OFDMA and UL MU-MIMO consideration to be no less than the number of active latency sensitive users. The latency sensitive users can be detected based on heuristics, determined based on payload, or in another manner. In this case, the user may only estimate the throughput for the UL TX modes involving equal to or greater than the maximum number users (such as for n-user to a maximum number of users).

In some examples, the AP estimates the throughput for the UL SU mode by calculating the peak throughput of the UL SU TX mode using the identified PHY Rate, overhead, and payload parameters for the highest scheduling weight user. In an example formula, the throughput for the highest scheduling user for the UL SU TX mode may be estimated as follows:

Payload=min(buffer/rate,max_psdu_time)×rate,

where the payload is equal to the rate multiplied by the smaller of a period for buffered data (at the rate) or the maximum data unit length physical layer convergence protocol (PLCP) service data unit (PSDU) length;

Duration=idle_period(#active users)+min(buffer/rate,max_psdu_time)+BA,

where the duration is equal to an idle period length (which may be based on the number of active users), the smaller of a period for the buffered data (at the rate) or the maximum PSDU length, and a period for the block ACK; and

R=Payload/Duration*(1−Collision Rate),

where the throughput is equal to the ratio of the payload and duration multiplied by the non-collision rate (1−collision rate).

In some examples, the AP estimates the throughput for the n-user UL OFDMA TX modes by calculating the peak throughput of the n-user UL OFDMA TX modes using the identified PHY Rate, overhead, and payload parameters for the highest scheduling weight user. In an example formula, the throughput for the highest scheduling user for the n-user UL OFDMA TX modes may be estimated as follows:

Payload=bits(OFDMA RU allocation(PSD_boosted_rate,payload)),

where the payload size is the number of bits (based on the number of RUs allocated to the STA) and the rate (such as the PSD boosted rate) of the STA;

Duration=idle_period(AP_EDCA)+PPDU(OFDMA RU allocation (PSD_boosted_rate))+trigger+SIFS+M-STA BA(n-user)+SIFS,

where the duration is equal to an idle period length (which may be based on a time to contend for access to medium, such as with EDCA), PPDU length (which may be based on the RU allocation and the rate (such as the PSD boosted rate), and periods for the trigger, SIFS, block ACK, and SIFS; and

R=Payload/Duration,

where the throughput is equal to the ratio of the payload and duration.

In some examples, the AP estimates the throughput for the n-user UL MU-MIMO TX modes by calculating the peak throughput of the n-user UL MU-MIMO TX modes using the identified PHY Rate, overhead, and payload parameters for the highest scheduling weight user. In an example formula, the throughput for the highest scheduling user for the n-user UL MU-MIMO TX modes may be estimated as follows:

Payload=bits(MU-MIMO SS allocation(MU_rate,payload)),

where the payload size is the number of bits (based on the spatial streams allocated to the STA) and the rate of the STA;

Duration=idle period(AP_EDCA)+PPDU(MU-MIMO SS allocation (MU_rate,payload))+trigger+SIFS+M-STA BA(n-user)+SIFS,

where the duration is equal to an idle period length (which may be based on a time to contend for access to medium, such as with EDCA), PPDU length (which may be based on the spatial stream allocations and the rat, and periods for the trigger, SIFS, block ACK, and SIFS; and

R=Payload/Duration,

where the throughput is equal to the ratio of the payload and duration.

The parameters in the formulas above may be examples, and other parameters may be used to determine the payload and durations based on the frames involved and the like.

Thus, after estimating the throughputs for the different UL TX modes, the AP can selects the UL TX mode with the highest throughput.

Using the dynamic UL TX mode selection, the AP may dynamically change the UL TX mode as the conditions change. For example, as the numbers of active users changes (such as to 1 or more than 1 active users and/or to above or below 4 active users) the UL TX modes may change. In another example, as the number of UL delay sensitive active users changes, the minimum number of users for UL OFDMA and/or UL MU-MIMO may change. In yet another example, as the GI of the users change, the UL TX modes may change. In yet another example, as the payload sizes of the users change (such as to more small payload, which may be payloads less than 300 μs, or to more large payloads), the UL TX mode may change.

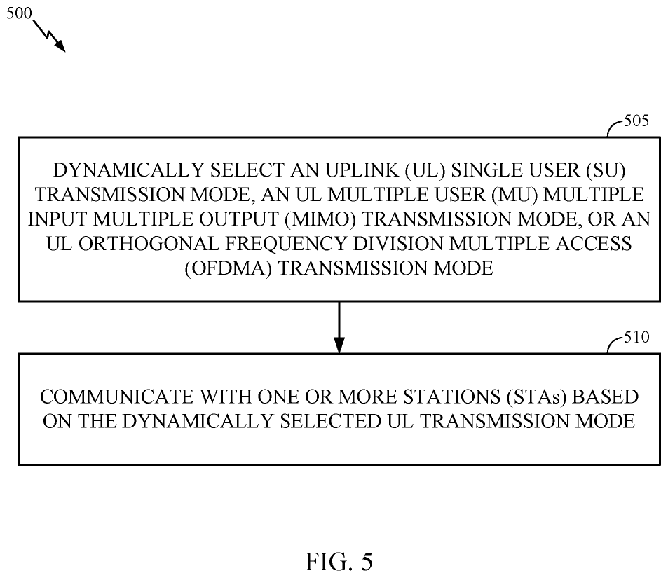

FIG. 5 is a flow diagram illustrating example operations 500 for wireless communication, in accordance with certain aspects of the present disclosure. The operations 500 may be performed, for example, by an AP (e.g., such as the AP 110₁ in the network 100). Operations 500 may be implemented as software components that are executed and run on one or more processors (e.g., controller 230 of FIG. 2). Further, the transmission and reception of signals by the AP in operations 500 may be enabled, for example, by one or more antennas (e.g., antennas 224 of FIG. 2). In certain aspects, the transmission and/or reception of signals by the AP may be implemented via a bus interface of one or more processors (e.g., controller 230) obtaining and/or outputting signals.

The operations 500 may begin, at 505, by dynamically select an UL SU transmission mode, an UL MU MIMO transmission mode, or an UL OFDMA transmission mode.

At 510, the AP communicates with one or more STAs (such as non-AP STAs or user terminals) based on the dynamically selected UL transmission mode.

In some examples, the AP selects the UL SU transmission mode when there is only one active UL STA.

In some examples, the AP selects the UL transmission mode based on heuristics when the one or more STAs have similar traffic and channel conditions and the AP selects the UL transmission mode based on a highest estimated throughput of the UL transmission modes when the one or more STAs do not have similar traffic and channel conditions.

In some examples, selecting the UL transmission mode based on heuristics includes, when there is more than one active UL STA: selecting the UL MU-MIMO transmission mode when a highest scheduling weight STA is UL MU-MIMO capable, at least one STA has a payload equal to or above a threshold, and at least one STA has a rate equal to or above a threshold. In some examples, selecting the UL transmission mode based on heuristics includes, when there is more than one active UL STA and when the highest scheduling weight STA is not UL MU-MIMO capable, all of the STAs have a payload below the threshold, and all of the STAs have a rate below the threshold: selecting the UL OFDMA transmission mode when at least two highest scheduling STAs that have a payload below a threshold; selecting the UL OFDMA transmission mode when there are more than four STAs and UL OFDMA power boosted throughput is higher than UL SU throughput or the UL SU caused collisions are high; and selecting the UL SU transmission mode when at least two highest scheduling STAs do have a payload below the threshold and the UL OFDMA power boosted throughput is higher than the UL SU throughput.

In some examples, selecting the UL transmission mode based on estimated throughput includes, when there is more than one active UL STA, includes estimating a throughput of each of the UL transmission modes based, at least in part, on a number of STAs, UL traffic types, payloads of the STAs, and/or PHY rates of the STAs; and selecting the UL transmission mode with the highest estimated throughput. In some examples, the UL traffic types include latency sensitive traffic types.

In some examples, the PHY rates include PHY rates, at a same path loss, taking into one or more of account MCS, NSS, and GI, for each of the UL transmission modes; and an estimated overhead for each of the UL transmission modes taking into account one or more of contention protocol, an expected number of collisions, triggers, and acknowledgements, associated with the UL transmission modes. In some examples, the PHY rates includes estimated PHY rates for each of: UL SU, UL OFDMA PSD boosted RU26, UL OFDMA PSD boosted RU52, UL OFDMA PSD boosted RU106, UL OFDMA PSD boosted RU242, UL OFDMA PSD boosted RU484, UL OFDMA PSD boosted RU996, UL MU-MIMO MU-1, UL MU-MIMO MU-2, UL MU-MIMO MU-3, UL MU-MIMO MU-4, UL MU-MIMO MU-5, UL MU-MIMO MU-6, UL MU-MIMO MU-7, and UL MU-MIMO MU-8.

In some examples, the AP sets a minimum number of users for the UL OFDMA and UL MU-MIMO transmission modes to be equal to or greater than a number of active latency sensitive users and estimates the throughput only for the UL transmission modes equal to and above the minimum number of users.

In some examples, the AP estimates the throughput of the UL transmission modes by calculating a peak throughput of each of the UL transmission mode using a PHY rate, overhead, and payload of the highest scheduling weight STA.

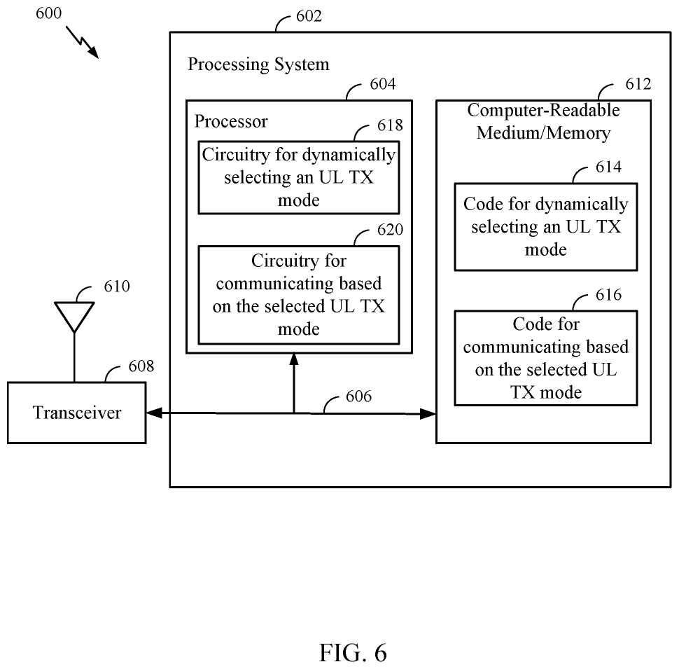

FIG. 6 illustrates a communications device 600 that may include various components (e.g., corresponding to means-plus-function components) configured to perform operations for the techniques disclosed herein, such as the operations illustrated in FIG. 5. The communications device 600 includes a processing system 602 coupled to a transceiver 608 (e.g., a transmitter and/or a receiver). The transceiver 608 is configured to transmit and receive signals for the communications device 600 via an antenna 610, such as the various signals as described herein. The processing system 602 may be configured to perform processing functions for the communications device 600, including processing signals received and/or to be transmitted by the communications device 600.

The processing system 602 includes a processor 604 coupled to a computer-readable medium/memory 612 via a bus 606. In certain aspects, the computer-readable medium/memory 612 is configured to store instructions (e.g., computer-executable code) that when executed by the processor 604, cause the processor 604 to perform the operations illustrated in FIG. 5, or other operations for performing the various techniques discussed herein for dynamically selecting and trigger an UL TX mode. In certain aspects, computer-readable medium/memory 612 stores code 614 for dynamically selecting an UL TX mode and code 616 for communicating based on the UL TX mode, in accordance with aspects of the present disclosure. In certain aspects, the processor 604 has circuitry configured to implement the code stored in the computer-readable medium/memory 612. The processor 604 includes circuitry 618 for dynamically selecting an UL TX mode and circuitry 620 for communicating based on the UL TX mode, in accordance with aspects of the present disclosure.

The various operations of methods described above may be performed by any suitable means capable of performing the corresponding functions. The means may include various hardware or software component(s) or module(s), including, but not limited to a circuit, an application specific integrated circuit (ASIC), or processor.

Means for communicating or means for receiving may include a receiver (such as the receiver unit 222) or an antenna(s) 224 of the AP 110 illustrated in FIG. 2. Means for communicating, means for transmitting, or means for outputting may include a transmitter (such as the transmitter unit 222) or an antenna(s) 224 of the AP 110 illustrated in FIG. 2. Means for selecting, means for estimating, means for setting, or means for determining may include a processing system, which may include one or more processors, such as the RX data processor 242, the TX data processor 210, the TX spatial processor 220, RX spatial processor 240, or the controller 230 of the AP 110 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communications, comprising:
a processing system configured to dynamically select an uplink (UL) single user (SU) transmission mode, an UL multiple user (MU) multiple input multiple output (MIMO) transmission mode, or an UL orthogonal frequency division multiple access (OFDMA) transmission mode; and
an interface configured to communicate with one or more stations (STAs) based on the dynamically selected UL transmission mode.

2. The apparatus of claim 1, wherein the processing system is configured to select the UL SU transmission mode when there is only one active UL STA.

3. The apparatus of claim 2, wherein the processing system configured is configured to dynamically select by:
selecting the UL transmission mode based on heuristics when the one or more STAs have similar traffic and channel conditions; and
selecting the UL transmission mode based on a highest estimated throughput of the UL transmission modes when the one or more STAs do not have similar traffic and channel conditions.

4. The apparatus of claim 2, wherein the processing system configured is configured to dynamically select by, when there is more than one active UL STA:
selecting the UL MU-MIMO transmission mode when a highest scheduling weight STA is UL MU-MIMO capable, at least one STA has a payload equal to or above a threshold, and at least one STA has a rate equal to or above a threshold; and
when the highest scheduling weight STA is not UL MU-MIMO capable, all of the STAs have a payload below the threshold, and all of the STAs have a rate below the threshold:
selecting the UL OFDMA transmission mode when at least two highest scheduling STAs that have a payload below a threshold;
selecting the UL OFDMA transmission mode when there are more than four STAs and UL OFDMA power boosted throughput is higher than UL SU throughput or UL SU caused collisions are above a threshold; and
selecting the UL SU transmission mode when at least two highest scheduling STAs do have a payload below the threshold and the UL OFDMA power boosted throughput is higher than the UL SU throughput.

5. The apparatus of claim 2, wherein the processing system configured is configured to dynamically select by, when there is more than one active UL STA:
estimating a throughput of each of the UL transmission modes based, at least in part, on one or more of: a number of STAs, UL traffic types, payloads of the STAs, physical layer (PHY) rates of the STAs; and
selecting the UL transmission mode with the highest estimated throughput.

6. The apparatus of claim 5, wherein:
the UL traffic types comprise latency sensitive traffic types;
the PHY rates comprises PHY rates, at a same path loss, taking into one or more of account modulation coding scheme (MCS), number of spatial streams (NSS), and guard interval (GI), for each of the UL transmission modes; and
an estimated overhead for each of the UL transmission modes taking into account one or more of contention protocol, an expected number of collisions, triggers, and acknowledgements, associated with the UL transmission modes.

7. The apparatus of claim 6, wherein the PHY rates comprise estimated PHY rates for each of: UL SU, UL OFDMA power spectral density (PSD) boosted RU26, UL OFDMA PSD boosted RU52, UL OFDMA PSD boosted RU106, UL OFDMA PSD boosted RU242, UL OFDMA PSD boosted RU484, UL OFDMA PSD boosted RU996, UL MU-MIMO MU-1, UL MU-MIMO MU-2, UL MU-MIMO MU-3, UL MU-MIMO MU-4, UL MU-MIMO MU-5, UL MU-MIMO MU-6, UL MU-MIMO MU-7, and UL MU-MIMO MU-8.

8. The apparatus of claim 5, wherein the processing system is further configured to:
set a minimum number of users for the UL OFDMA and UL MU-MIMO transmission modes to be equal to or greater than a number of active latency sensitive users; and
estimate the throughput only for the UL transmission modes equal to and above the minimum number of users.

9. The apparatus of claim 5, wherein the processing system is configured to estimate the throughput of the UL transmission modes by calculating a peak throughput of each of the UL transmission mode using a PHY rate, overhead, and payload of the highest scheduling weight STA.

10. A method for wireless communication by an access point (AP), comprising:
dynamically selecting an uplink (UL) single user (SU) transmission mode, an UL multiple user (MU) multiple input multiple output (MIMO) transmission mode, or an UL orthogonal frequency division multiple access (OFDMA) transmission mode; and
communicating with one or more stations (STAs) based on the dynamically selected UL transmission mode.

11. The method of claim 10, wherein the dynamically selecting comprising selecting the UL SU transmission mode when there is only one active UL STA.

12. The method of claim 11, wherein the dynamically selecting comprises:
selecting the UL transmission mode based on a heuristics when the one or more STAs have similar traffic and channel conditions; and
selecting the UL transmission mode based on a highest estimated throughput of the UL transmission modes when the one or more STAs do not have similar traffic and channel conditions.

13. The method of claim 11, wherein the dynamically selecting comprises, when there is more than one active UL STA:
selecting the UL MU-MIMO transmission mode when a highest scheduling weight STA is UL MU-MIMO capable, at least one STA has a payload equal to or above a threshold, and at least one STA has a rate equal to or above a threshold; and
when the highest scheduling weight STA is not UL MU-MIMO capable, all of the STAs have a payload below the threshold, and all of the STAs have a rate below the threshold:
selecting the UL OFDMA transmission mode when at least two highest scheduling STAs that have a payload below a threshold;
selecting the UL OFDMA transmission mode when there are more than four STAs and UL OFDMA power boosted throughput is higher than UL SU throughput or UL SU caused collisions are above a threshold; and
selecting the UL SU transmission mode when at least two highest scheduling STAs do have a payload below the threshold and the UL OFDMA power boosted throughput is higher than the UL SU throughput.

14. The method of claim 11, wherein the dynamically selecting comprises, when there is more than one active UL STA:
estimating a throughput of each of the UL transmission modes based, at least in part, on one or more of: a number of STAs, UL traffic types, payloads of the STAs, physical layer (PHY) rates of the STAs; and
selecting the UL transmission mode with the highest estimated throughput.

15. The method of claim 14, wherein:
the UL traffic types comprise latency sensitive traffic types;
the PHY rates comprises PHY rates, at a same path loss, taking into one or more of account modulation coding scheme (MCS), number of spatial streams (NSS), and guard interval (GI), for each of the UL transmission modes; and
an estimated overhead for each of the UL transmission modes taking into account one or more of contention protocol, an expected number of collisions, triggers, and acknowledgements, associated with the UL transmission modes.

16. The method of claim 15, wherein the PHY rates comprise estimated PHY rates for each of: UL SU, UL OFDMA power spectral density (PSD) boosted RU26, UL OFDMA PSD boosted RU52, UL OFDMA PSD boosted RU106, UL OFDMA PSD boosted RU242, UL OFDMA PSD boosted RU484, UL OFDMA PSD boosted RU996, UL MU-MIMO MU-1, UL MU-MIMO MU-2, UL MU-MIMO MU-3, UL MU-MIMO MU-4, UL MU-MIMO MU-5, UL MU-MIMO MU-6, UL MU-MIMO MU-7, and UL MU-MIMO MU-8.

17. The method of claim 14, further comprising:
setting a minimum number of users for the UL OFDMA and UL MU-MIMO transmission modes to be equal to or greater than a number of active latency sensitive users; and
estimating the throughput only for the UL transmission modes equal to and above the minimum number of users.

18. The method of claim 14, wherein estimating the throughput of the UL transmission modes comprises calculating a peak throughput of each of the UL transmission mode using a PHY rate, overhead, and payload of the highest scheduling weight STA.

19. An apparatus for wireless communication, comprising:
means for dynamically selecting an uplink (UL) single user (SU) transmission mode, an UL multiple user (MU) multiple input multiple output (MIMO) transmission mode, or an UL orthogonal frequency division multiple access (OFDMA) transmission mode; and
means for communicating with one or more stations (STAs) based on the dynamically selected UL transmission mode.
